(19) United States
(12) Patent Application Publication
(10) Pub. No.: US 2008/0026256 A1
(43) Pub. Date: Jan. 31, 2008

(54) MAGNETIC RECORDING MEDIUM

(75) Inventor: Atsushi Kato, Miyagi (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/782,387

(22) Filed: Jul. 24, 2007

(30) Foreign Application Priority Data
Jul. 25, 2006 (JP) P2006-201765

(51) Int. Cl. G11B 5/66

(52) U.S. Cl. 428/832; 428/847.2

(57) ABSTRACT

A magnetic recording medium is provided. The magnetic recording medium includes a nonmagnetic support, a lower nonmagnetic layer in which a nonmagnetic powder is dispersed in a binder and which is provided on the nonmagnetic support, and a magnetic layer in which a magnetic powder is dispersed in a binder and which is provided on the lower nonmagnetic layer. The nonmagnetic support is made of a polyethylene terephthalate having a glass transition temperature of 125° C. or higher. The ratio of the thickness of the nonmagnetic support to the total thickness of the magnetic recording medium is in the range of 70% to 85%.

### CROSS REFERENCES TO RELATED APPLICATIONS

The present application claims priority to Japanese Patent Application JP 2006-201765 filed in the Japanese Patent Office on Jul. 25, 2006, the entire contents of which are incorporated herein by reference.

### BACKGROUND

The present disclosure relates to a data-storage magnetic recording medium capable of storing a large amount of data for a long time, and in particular, to a general-purpose coat-type magnetic recording medium for storing data.

Recently, with the popularization of computers, development of magnetic recording media capable of storing a large amount of digital data for a long time and improvement in characteristics of magnetic recording media have been desired.

In order to realize high-density recording on a coat-type magnetic recording medium, it is important that not only metal fine particles be used as a ferromagnetic powder, but also the surface of the medium be made extremely smooth to minimize spacing loss and to decrease output loss due to recording demagnetization. Examples of methods of achieving these objects include increasing the coercive force and the saturation magnetization of the ferromagnetic powder, improving the uniformity of coercive force distribution of the ferromagnetic powder, imparting of perpendicular anisotropy, and reducing the thickness of a magnetic layer.

Among these methods, improving the ferromagnetic powder is a method of directly improving the output. As regards making such an improvement in the coercive force and the saturation magnetization, for example, the elemental composition of ferromagnetic powders has been studied. Consequently, metal fine particles having a coercive force of more than 160 kA/m, and furthermore, metal fine particles having a saturation magnetization of more than 140 Am²/kg have been developed. The particle size distribution of a ferromagnetic powder is reflected in the coercive force distribution. By making the particle size uniform, the coercive force distribution is also markedly improved.

The imparting of perpendicular anisotropy is a method of realizing high-density recording by performing perpendicular magnetic recording. In the case of a coat-type magnetic recording medium, this method is mainly conducted by controlling the magnetic orientation of a ferromagnetic powder. For example, when acicular particles are used, a vertical orientation treatment or an oblique orientation treatment is performed on a coated film. However, these orientation treatments have not yet been practically used because of problems such as difficulty of orientation control, and unevenness of the surface of the coated film due to the orientation.

It is believed that reducing the thickness of a magnetic layer is very effective as a method of decreasing self demagnetization loss. However, when the thickness of the magnetic layer is simply reduced to, for example, 1 μm or less, the surface configuration of a nonmagnetic support easily appears on the surface of the magnetic layer, resulting in difficulty in smoothening the surface of the magnetic layer. Therefore, when the thickness of the magnetic layer is reduced, a multilayer coating structure is often used in which a nonmagnetic coating layer is interposed between the nonmagnetic support and the magnetic layer. When a nonmagnetic layer functioning as a buffer layer is interposed as described above, a gap can be formed between the surface of the nonmagnetic support and the surface of the magnetic layer. In this case, the surface configuration of the nonmagnetic support does not easily appear on the surface of the magnetic layer. Accordingly, a magnetic layer having a small thickness can be formed with a smooth surface configuration.

Various improvements have been proposed for such multilayer-coating-type magnetic recording media. Examples thereof include a method of forming a lower nonmagnetic coating layer having a thickness in the range of 0.5 to 3.5 μm (see Japanese Unexamined Patent Application Publication No. 63-187418), a method of adding an appropriate amount of carbon black to a lower nonmagnetic layer (see Japanese Unexamined Patent Application Publication No. 4-238111), a method of coating the surface of a nonmagnetic oxide constituting a lower nonmagnetic layer with an inorganic substance (see Japanese Unexamined Patent Application Publication No. 5-182177), a method of using at least two types of nonmagnetic powders having different sizes for a lower nonmagnetic layer (see Japanese Unexamined Patent Application Publication No. 5-274651), a method of controlling the standard deviation of the thickness of an upper magnetic layer within a specific range (see Japanese Unexamined Patent Application Publication No. 5-298653), and a method of forming an upper magnetic layer composed of at least two magnetic sublayers (see Japanese Unexamined Patent Application Publication Nos. 6-162485 and 6-162489).

Examples of known materials used for such a lower nonmagnetic layer include a mixture containing nonmagnetic iron oxide, such as hematite, as a main component; an abrasive material such as titanium oxide or alumina; an antistatic agent, such as carbon black, for the purpose of decreasing the electrical resistance of a magnetic recording medium; a lubricant; and a binder (see Japanese Unexamined Patent Application Publication No. 2005-259276), and fine particles containing goethite (iron oxyhydroxide) as a main component (see Japanese Unexamined Patent Application Publication Nos. 11-3517 and 2005-228377).

In particular, because of a market demand that the cost per gigabyte (GB) is emphasized in magnetic tapes for general-purpose data storage, high-density recording in magnetic recording media has been desired. In order to realize high-density recording, decreasing the recording wavelength and the size of recording tracks is effective. However, reducing the size of recording tracks is disadvantageous in that a shift of the recording tracks can easily occur because of heat during running of a magnetic tape or thermal deformation during the storage of the tape. Accordingly, demand for improving characteristics, such as thermal dimensional stability and storage stability in the operating environment of magnetic tapes, has been increasing.

In multilayer-coating-type magnetic recording media, the performance of a nonmagnetic support is important in order to impart high durability and high reliability for withstanding repeated running, e.g., running several tens of thousand times to several hundreds of thousand times, in linear recording tape media such as a digital linear tape (DLT) and linear tape-open (LTO).

In the linear recording tape media, in order to increase the transfer rate, recording is simultaneously performed with a plurality of heads, and in addition, a tape is stably slid on the heads at a high speed. Accordingly, the tension applied to the magnetic tape in a drive is about 200 g per inch, which is two times to three times the stress applied to a helical-scan tape drive used for a video tape recorder (VTR) or a digital data storage (DDS).

Consequently, when a nonmagnetic support of a magnetic tape has a low strength and the tension is applied to the magnetic tape in a drive, the dimensions of the tape may be changed during recording and reproducing. As a result, the recorded tracks are not followed properly, resulting in off-track. Accordingly, a decrease in the output due to the off-track easily occurs. Therefore, servo techniques such as a magnetic servo system and an optical servo system have been studied. However, in the case where a nonmagnetic support whose dimensions are easily changed by an effect of long-term storage or the like is used, even when such servo techniques are employed, the magnetic tape is easily subjected to the effect of off-track and does not have satisfactory reliability and durability.

Hitherto, in order to obtain satisfactory strength and dimensional characteristics for a nonmagnetic support, for example, Japanese Unexamined Patent Application Publication No. 2005-196944 discloses a method of increasing the mechanical strength of a nonmagnetic support and ensuring the dimensional stability thereof by forming a metal layer on each surface of a polyester film. Japanese Unexamined Patent Application Publication Nos. 2002-358629 and 11-283234 disclose methods of decreasing the thickness of layers of a magnetic tape and maintaining an appropriate mechanical strength thereof by forming a metal reinforcing layer on a polymer film used as a nonmagnetic support by a vacuum thin-film deposition technique. Such a metal reinforcing layer has a mechanical strength that is markedly higher than that of a polymer film having the same thickness. Accordingly, a metal reinforcing layer having even a small thickness is effective, thus realizing a decrease in the thickness of layers of a magnetic tape.

Similarly, Japanese Unexamined Patent Application Publication No. 2004-310899 discloses examples of polyesters prepared by forming gas barrier layers on the surfaces of a polyester film, such as a polyethylene terephthalate or polyethylene-2,6-naphthalate film, which has both excellent dimensional stability and an excellent slitting property.

However, since the deposition of a metal film causes a marked increase in the cost, advantages of a coat-type magnetic recording medium, namely, a low cost and a high productivity are lost. Aromatic polyamides having a high rigidity may also be used as a nonmagnetic support from the viewpoint of strength and dimensional stability. However, aromatic polyamides are expensive and cause an increase in the cost, and thus, are not practically used as a support of a general-purpose recording medium.

According to Japanese Unexamined Patent Application Publication No. 2006-73047, in order to prevent degradation in the quality and a decrease in the yield caused by dimensional changes due to a stress generated by thermal contraction of a nonmagnetic support roll and thermal expansion of a core, various methods have been studied. Examples thereof include a method of controlling the winding conditions by winding at a specific temperature and a specific pressure, a method of controlling the glass transition temperature (Tg) of a binder in order to stabilize storage characteristics, and a method of controlling the type and the amount of curing agent used.

It is desirable to provide a magnetic recording medium which can withstand repeated running and have satisfactory long-term storage characteristics, in which an industrially inexpensive material can be used, in particular, which has excellent long-term storage characteristics and in which durability during repeated running can be improved.

### SUMMARY

In a magnetic recording medium according to an embodiment, a film prepared by adding a high-melting-point component to polyethylene terephthalate (hereinafter referred to as “PET”) wherein the PET film has a Tg higher than the Tg of known PET films (glass transition temperature: 115° C. to 120° C.) is used as a nonmagnetic support. Furthermore, by controlling the ratio of the strength of the PET film in the machine direction (MD) to that in the transverse direction (TD) (strength (Young's modulus) in the longitudinal direction: strength (Young's modulus) in the width direction) and the proportion of the thicknesses of the nonmagnetic support, a magnetic layer, and a back coat layer in the magnetic recording medium to a certain range, the rupture strength of the magnetic recording medium can be increased.

A magnetic recording medium according to an embodiment includes a nonmagnetic support; a lower nonmagnetic layer in which a nonmagnetic powder is dispersed in a binder and which is provided on the nonmagnetic support; and a magnetic layer in which a magnetic powder is dispersed in a binder and which is provided on the lower nonmagnetic layer, wherein the nonmagnetic support is made of a polyethylene terephthalate having a glass transition temperature (Tg) of 125° C. or higher, and the ratio of the thickness (t) of the nonmagnetic support to the total thickness (T) of the magnetic recording medium is in the range of 70% to 85%.

In the magnetic recording medium according to an embodiment, the nonmagnetic support is preferably made of a polyethylene terephthalate having a Young's modulus in the longitudinal direction of 6,000 N/mm² or more and a Young's modulus in the width direction of 4,000 N/mm² or more.

In the magnetic recording medium according to an embodiment, the nonmagnetic support preferably has a thickness of 7 μm or less.

According to the embodiments, a coat-type magnetic recording medium having a high rupture strength, excellent durability and productivity, and a high density and a large capacity can be obtained.

Additional features and advantages are described herein, and will be apparent from, the following Detailed Description and the figures.

### BRIEF DESCRIPTION OF THE FIGURES

FIG. 1 is a schematic cross-sectional view of a magnetic recording medium according to an embodiment.

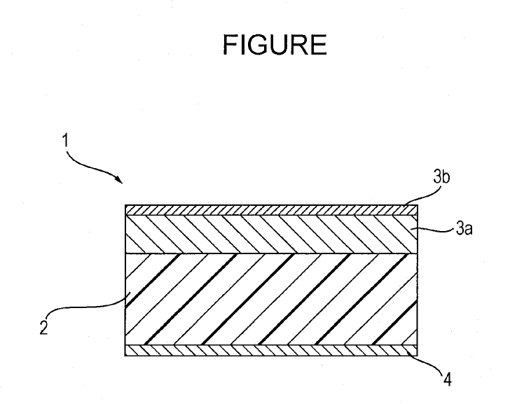

### DETAILED DESCRIPTION

Embodiments are described below with reference to the drawing.

FIGURE is a schematic cross-sectional view of a magnetic recording medium according to an embodiment. In a magnetic recording medium 1 shown in the FIGURE, a lower nonmagnetic layer 3a and a magnetic layer 3b are formed on a surface of a nonmagnetic support 2 in that order. A back coat layer 4 is formed on a back surface of the magnetic surface (another surface of the nonmagnetic support 2) according to need in order to ensure the running stability of the magnetic recording medium 1.

PET Base

In the present embodiment, a reinforced PET containing a high-melting-point component is used as the nonmagnetic support 2. The glass transition temperature (Tg) of a PET resin is normally in the range of 70° C. to 80° C. However, in a PET film that is used for a nonmagnetic support of a magnetic recording medium and that has a thickness in the range of 4 to 15 μm, the glass transition temperature thereof is in the range of 110° C. to 120° C. because of an effect of molecular orientation due to stretching during the film formation, an effect of a polymer alloy obtained by the addition of another resin having a high melting point, an effect of a filler component, and the like.

In linear tapes used for, for example, the LTO format, a polyethylene naphthalate (hereinafter referred to as “PEN”) film having a high film strength (Young's modulus), excellent running durability and storage characteristics, and a Tg in the range of 150° C. to 155° C., which is higher than that of known PET films is used. However, since the planarity of the PEN molecule is strong, PEN films tend to be cut in a certain direction. In particular, surfaces of separate films are easily adhered together due to moisture being absorbed during the production process. Accordingly, the film is often cut from an edge during an application step or a cutting step.

In addition, the cutting property of a PEN film is inferior to that of a PET film because of a higher strength of the PEN film. Accordingly, for example, a high-edge phenomenon may occur in which an edge of a pancake (i.e., film) obtained after cutting is deformed in the upward direction, and edge damage may occur in which an edge of the film flaps. In addition, the lifetime of a knife used for the cutting is short. Thus, the productivity of a PEN film is significantly affected by these problems.

Technical development has occurred for solving these problems concerning PEN and for realizing characteristics equal to or higher than those of PEN using PET, which is a resin with a higher versatility.

In the present invention, in order to further increase the Tg of PET, a reinforced PET containing a high-melting-point component is used. For this purpose, it is necessary to add a resin component having a high Tg to a PET resin prior to the formation of a PET film, and to allow the resins to be sufficiently mixed with an extruder.

The resin component having a high Tg contained in the PET resin is a high-melting-point resin that has a Tg exceeding 150° C. and that has compatibility with the PET resin. Specific examples thereof include para-aromatic polyamide (aramid) resins, polyimide resins, polysulfones, and polyethersulfones. These resins are blended with a PET resin in an amount of 1 to 50 weight percent. Examples of polyetherimide resins include ULTEM manufactured by GE Plastics and SUPERIOUT manufactured by Mitsubishi Plastics, Inc. These resins are appropriately mixed with a PET resin.

In addition to the high-melting-point resin component, in order to increase the Young's modulus, alumina particles; wet-process or dry-process silica particles and/or cross-linked silicone resin particles; or cross-linked silicone resin particles and cross-linked polystyrene particles are added according to need. Thereby, the range of the Young's modulus of MD/TD can be achieved in the embodiments.

An example of a PET film having a high Tg used in the embodiment is a biaxially oriented PET film Lumirror (SPALTAN) manufactured by Toray Industries, Inc. In the embodiment, the Tg of the nonmagnetic support itself is about 130° C. or higher, which is 10° C. to 20° C. higher than that of general-purpose PET films. Accordingly, in a running test in a high-temperature environment, more specifically, in a running test in an environment of 45° C. (the temperature in a drive being about 55° C.) and in a storage test in a high-temperature environment of 60° C., durability and storage stability that are equal to or higher than those of PEN films can be achieved.

The transverse dimensional stability (TDS) for a change in the environment of the temperature and humidity of a tape and a change in the tension applied to the tape is one of important characteristics used in measurement of a margin for off-track during reproducing. In the embodiment, in particular, by specifying the proportion of the thicknesses of a film constituting the nonmagnetic support and the coating films in the magnetic recording medium and the range of Young's modulus of MD/TD of the nonmagnetic support, the TDS can be decreased to 1,200 ppm or less. Accordingly, when a data cartridge after recording is stored for a long time, the reproducibility of data can be improved. For the purpose of this description, the term “MD direction and TD direction of a magnetic recording medium” means that, when the magnetic recording medium is a magnetic tape, the longitudinal direction of the magnetic recording medium is defined as an MD direction and the width direction of the magnetic recording medium is defined as a TD direction.

A base thickness (the thickness of the nonmagnetic support) is determined by the format of the storage device. In consideration of the fact that the drive tension used in each format of a ½-inch linear tape is about 100 gf, the rupture strength, and the like, a base thickness in the range of 4 to 7 μm is more effective. The ratio of the base thickness to the total thickness of the magnetic recording medium is in the range of 70% to 85%. In addition, the Young' modulus in the MD direction of the base film is 6,000 N/mm² or more, and the Young' modulus in the TD direction thereof is 4,000 N/mm² or more. Thereby, the measurement value of TDS of 1,200 ppm or less can be realized, thus providing a magnetic recording medium having more excellent storage stability.

In the magnetic recording medium according to an embodiment, any known ferromagnetic powders, binders, abrasive materials, antistatic agents, and antirust agents that are mixed in the magnetic layer, and any known solvents used for preparing a magnetic coating composition may be used, and these components are not particularly limited.

Examples of the ferromagnetic powders used in the embodiment include known ferromagnetic materials such as γ-FeOₓ (x=1.33 to 1.5), Co-modified γ-FeOₓ (x=1.33 to 1.5), ferromagnetic alloys containing Fe, Ni, or Co as a main component (75% or more), barium ferrite, and strontium ferrite. In addition to predetermined atoms, these ferromagnetic powders may contain other atoms such as Al, Si, S, Sc, Ti, V, Cr, Cu, Y, Mo, Rh, Pd, Ag, Sn, Sb, Te, Ba, Ni, Ta, W, Re, Au, Hg, Pb, Bi, La, Ce, P, Mn, Zn, Co, Sr, or B. In the present invention, more useful magnetic powders are ferromagnetic metal fine particles. When the saturation magnetization (σs) is in the range of 100 to 200 Am²/kg, the specific surface area is in the range of 45 to 60 M²/g, as measured by a BET method, and the coercive force is in the range of 150 to 300 kA/m, a marked effect can be obtained.

Any known binders can be used in the present embodiment. Specific examples thereof include vinyl chloride-vinyl acetate copolymers, vinyl chloride-vinyl acetate-vinyl alcohol copolymers, vinyl chloride-vinylidene chloride copolymers, vinyl chloride-acrylonitrile copolymers, vinyl chloride-vinyl acetate-maleic acid copolymers, acrylate-vinylidene chloride copolymers, acrylate-acrylonitrile copolymers, methacrylic acid-vinylidene chloride copolymers, methacrylate-styrene copolymers, thermoplastic polyurethane resins, phenoxy resins, polyvinyl fluoride, vinylidene chloride-acrylonitrile copolymers, butadiene-acrylonitrile copolymers, acrylonitrile-butadiene-methacrylic acid copolymers, polyvinyl butyral, cellulose derivatives, styrene-butadiene copolymers, polyester resins, phenolic resins, epoxy resins, thermosetting polyurethane resins, urea resins, melamine resins, alkyd resins, urea-formaldehyde resins, polyvinyl acetal resins, and mixtures thereof. Among these, for example, polyurethane resins, polyester resins, and acrylonitrile-butadiene copolymers, which are considered to impart flexibility; and cellulose derivatives, phenolic resins, and epoxy resins, which are considered to impart rigidity, are preferred.

In the present embodiment, carbon black can also be used for preventing electrostatic charges. As regards the carbon black, reference can be made to, for example, “Kabon-burakku Binran (Carbon Black Handbook) (edited by Kabon-burakku Kyokai (Carbon Black Association))”, and the type of carbon is not particularly limited.

As the carbon black used in the present invention, carbon black having a DBP oil absorption in the range of 30 to 150 mL/100 g, preferably in the range of 50 to 150 mL/100 g; an average particle diameter in the range of 5 to 150 nm, preferably in the range of 15 to 50 nm; and a specific surface area in the range of 40 to 300 m²/g, preferably in the range of 100 to 250 m²/g, as measured by a BET method is effective. Furthermore, the carbon black preferably has a tap density of 0.1 to 1 g/cc and a pH in the range of 2.0 to 10. When the carbon black has a larger DBP oil absorption, the viscosity of the resulting composition becomes high, so that the dispersibility is markedly degraded. In contrast, when the carbon black has a smaller DBP oil absorption, the dispersibility is poor, and thus the dispersing step takes a long time. When the carbon black has a smaller average particle diameter, the dispersion time is prolonged, but the surface properties are satisfactory. When the carbon black has a larger average particle diameter, the surface properties are poor. Therefore, the carbon black preferably has an average particle diameter which falls within the above range.

Examples of carbon black having the above-described properties include trade names RAVEN 1250 (particle diameter: 23 nm, BET value: 135.0 m²/g, DBP oil absorption: 58.0 mL/100 g), RAVEN 1255 (particle diameter: 23 nm, BET value: 125.0 m²/g, DBP oil absorption: 58.0 mL/100 g), RAVEN 1020 (particle diameter: 27 nm, BET value: 95.0 m²/g, DBP oil absorption: 60.0 mL/100 g), RAVEN 1080 (particle diameter: 28 nm, BET value: 78.0 m 2/g, DBP oil absorption: 65.0 mL/100 g), RAVEN 1035, RAVEN 1040, RAVEN 1060, RAVEN 3300, RAVEN 450, and RAVEN 780, manufactured by Columbia Carbon Co., Ltd.; and trade name CONDUCTEX SC manufactured by Columbia Carbon Co., Ltd. (particle diameter: 20 nm, BET value: 220.0 m²/g, DBP oil absorption: 115.0 mL/100 g). Examples of carbon black having the above-described properties further include trade name #80, manufactured by Asahi Carbon Co., Ltd. (particle diameter: 23 nm, BET value: 117.0 m²/g, DBP oil absorption: 113.0 mL/100 g); trade names #22B (particle diameter: 40 nm, BET value: 5.0 m²/g, DBP oil absorption: 131.0 mL/100 g) and #20B (particle diameter: 40 nm, BET value: 56.0 m²/g, DBP oil absorption: 115.0 mL/100 g), manufactured by Mitsubishi Chemical Corporation; and trade names BLACK PEARLS L (particle diameter: 24 nm, BET value: 250.0 m²/g, DBP oil absorption: 60.0 mL/100 g), BLACK PEARLS 800 (particle diameter: 17.0 nm, BET value: 240.0 m²/g, DBP oil absorption: 75.0 mL/100 g), BLACK PEARLS 1000, BLACK PEARLS 1100, BLACK PEARLS 700, and BLACK PEARLS 905, manufactured by Cabot Corporation. Furthermore, as carbon having a larger particle diameter, trade name MT CARBON (manufactured by Columbia Carbon Co., Ltd., particle diameter: 350 nm), trade name Thermax MT, or the like can be used.

Examples of the abrasive material that can be used include α-alumina having a rate of transformation to α-alumina of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular α-iron oxide obtained by dehydrating and annealing a material of magnetic iron oxide, and these materials, if desired, having a surface treated with aluminum and/or silica. These abrasive materials may be used alone or in combinations.

The nonmagnetic powder generally has a particle diameter in the range of 0.01 to 2 μm, preferably 0.015 to 1.00 μm, and more preferably 0.015 to 0.50 μm. If necessary, the same effect can be obtained by using nonmagnetic powders having different particle diameters in combination or using a single nonmagnetic powder having a broad particle size distribution. The nonmagnetic powder generally has a tap density in the range of 0.05 to 2 g/cc, preferably 0.2 to 1.5 g/cc.

The nonmagnetic powder generally has a specific surface area in the range of 1 to 200 m²/g, desirably 5 to 100 m²/g, and further desirably 7 to 80 m²/g. The nonmagnetic powder generally has a crystallite diameter in the range of 0.01 to 2 μm, preferably 0.015 to 1.00 μm, and further preferably 0.015 to 0.50 μm. The nonmagnetic powder generally has an oil absorption in the range of 5 to 100 mL/100 g, desirably 10 to 80 mL/100 g, and further desirably 20 to 60 mL/100 g, as measured using DBP. The nonmagnetic powder generally has a specific gravity in the range of 1 to 12, preferably 2 to 8.

The nonmagnetic powder may have any shapes such as an acicular shape, a spherical shape, a cubic shape, or a flaky shape. The nonmagnetic powder need not necessarily have a purity of 100%, and the surface of the nonmagnetic powder may be treated with another compound according to need. In such a case, in general, the effect of the nonmagnetic powder is not decreased as long as the nonmagnetic powder has a purity of 70% or more. For example, when titanium oxide is used as the nonmagnetic powder, the surface of the titanium oxide powder is generally treated with alumina. The ignition loss of the nonmagnetic powder is desirably 20% or less. Desirably, the inorganic powder has a Mohs hardness of 6 or more.

Furthermore, as the abrasive material, known materials having a Mohs hardness of 6 or more and containing, as a main component, for example, α-alumina, β-alumina, fused alumina, or titanium oxide may be used alone or in combinations. Specific examples of the abrasive materials used in the present invention include trade names UA5600 and UA5605, manufactured by SHOWA DENKO K.K.; trade names AKP-20, AKP-30, AKP-50, HIT-50, HIT-100, and ZA-G1, manufactured by Sumitomo Chemical Co., Ltd.; trade names G5, G7, and S-1, manufactured by Nippon Chemical Industrial Co., Ltd.; trade names TF-100, TF-120, TF-140, DPN 250BX, and DBN 270BX, manufactured by Toda Kogyo Corp.; trade names TTO-51B, TTO-55A, TTO-55B, TTO-55C, TTO-55S, TTO-55D, FT-1000, FT-2000, FTL-100, FTL-200, M-1, S-1, and SN-100, manufactured by Ishihara Sangyo Kaisha Ltd.; trade names ECT-52, STT-4D, STT-30D, STT-30, and STT-65C, manufactured by Titan Kogyo Kabushiki Kaisha; trade name T-1, manufactured by Mitsubishi Materials Corporation; trade names NS-O, NS-3Y, and NS-8Y, manufactured by Nippon Shokubai Co., Ltd.; trade names MT-100S, MT-100T, MT-150W, MT-500B, MT-600B, and MT-100F, manufactured by Tayca Corporation; trade names FINE X-25, BF-1, BF-10, BF-20, BF-1L, and BF-10P, manufactured by Sakai Chemical Industry Co., Ltd.; trade names DEFIC-Y and DEFIC-R, manufactured by Dowa Mining Co., Ltd.; and trade name Y-LOP, manufactured by Titan Kogyo Kabushiki Kaisha.

Any known lubricants can be used. Examples of the lubricants include higher fatty acid esters, silicone oil, fatty acid-modified silicones, fluorine-containing silicones, other fluorine-containing lubricants, polyolefins, polyglycols, esters and metal salts of alkylphosphoric acid, polyphenyl ethers, fluoroalkyl ethers, amine lubricants, such as amine salts of an alkylcarboxylic acid and amine salts of fluoroalkylcarboxylic acid, alcohols having 12 to 24 carbon atoms (which may include unsaturated bonds or may be branched), and higher fatty acid having 12 to 24 carbon atoms.

The higher fatty acid ester components used in the present invention include higher fatty acid esters each having 12 to 32 carbon atoms (which may include unsaturated bonds or may be branched). Examples thereof include methyl esters, ethyl esters, propyl esters, isopropyl esters, butyl esters, pentyl esters, hexyl esters, heptyl esters, and octyl esters of lauric acid, myristic acid, palmitic acid, stearic acid, isostearic acid, arachic acid, oleic acid, eicosanoic acid, elaidic acid, behenic acid, linoleic acid, and linolenic acid. Specific examples of compounds include butyl stearate, pentyl stearate, heptyl stearate, octyl stearate, isooctyl stearate, butoxyethyl stearate, octyl myristate, isooctyl myristate, and butyl palmitate. A plurality of lubricants may be mixed together.

As an antistatic agent, in addition to the above-mentioned carbon black, known antistatic agents such as natural surfactants, nonionic surfactants, and cationic surfactants can also be used.

In order to impart higher durability to the magnetic recording medium, an isocyanate curing agent having a number of average functional groups of 2 or more may be added. More specifically, polymeric substances of a polyisocyanate and adducts of a polyisocyanate with a polyol can be preferably used in the present invention. Among these, an isocyanurate each having a cyclic skeleton, which is a trimer of a diisocyanate, is a curing agent having a higher reactivity and effective to improve the durability.

Examples of isocyanate curing agents include aromatic polyisocyanates and aliphatic polyisocyanates. Adducts of these polyisocyanates with an active hydrogen compound are preferred. Examples of aromatic polyisocyanates include toluene diisocyanate (TDI), 1,3-xylene diisocyanate, 1,4-xylene diisocyanate, 4,4′-diphenylmethane diisocyanate (MDI), p-phenyl diisocyanate, m-phenyl diisocyanate, and 1,5-naphthyl diisocyanate. Examples of aliphatic polyisocyanates include hexamethylene diisocyanate (HDI), dicyclohexylmethane diisocyanate, cyclohexane diisocyanate, and isophorone diisocyanate (IPDI). Examples of active hydrogen compounds that form an adduct with the above polyisocyanates include ethylene glycol, 1,4-butanediol, 1,3-butanediol, neopentyl glycol, diethylene glycol, trimethyrolpropane, and glycerol. These active hydrogen compounds preferably have an average molecular weight in the range of 100 to 5,000.

The amount of curing agent added is generally in the range of 0 to 20 parts by weight, preferably 0 to 10 parts by weight, relative to the weight of the binder resin. Theoretically, the weight of curing agent containing an isocyanate in an amount corresponding to the equivalent amount of the active hydrogen contained in the polyurethane resin composition (or binder resin composition) is sufficient. However, in the actual production, the amount of isocyanate contained in the curing agent is decreased because of reaction with moisture or the like. Therefore, the isocyanate in an amount corresponding to the equivalent amount of the active hydrogen is usually insufficient. For this reason, it is effective that the curing agent is added in an excessive amount 10% to 50% larger than the equivalent amount of the active hydrogen.

When a curing agent composed of a polyisocyanate is used in the magnetic coating composition, the magnetic coating composition is applied, and a curing reaction is then accelerated at a temperature in the range of 40° C. to 80° C. for several hours, thus obtaining higher adhesiveness.

Examples of solvents that can be used for preparing the magnetic coating composition include ketone solvents, such as acetone, methyl ethyl ketone, methyl isobutyl ketone, and cyclohexanone; ester solvents, such as methyl acetate, ethyl acetate, butyl acetate, ethyl lactate, and ethyl acetate monoethyl ether; glycol ether solvents, such as glycol monoethyl ether and dioxane; aromatic hydrocarbon solvents, such as benzene, toluene, and xylene; and chlorine-containing solvents, such as methylene chloride, ethylene chloride, carbon tetrachloride, chloroform, ethylene chlorohydrin, and dichlorobenzene. Other known organic solvents can also be used.

As a method of preparing the magnetic coating composition, any known method can be employed. For example, a roll mill, a ball mill, a sand mill, a trone mill, a high-speed stone mill, a basket mill, a disper mixer, a homomixer, a kneader, a continuous kneader, an extruder, a homogenizer, and an ultrasonic dispersing machine can be used.

In the magnetic recording medium according to an embodiment, for example, as shown in the FIGURE, a nonmagnetic back coat layer 4 may be provided on another surface of the nonmagnetic support 2, the surface opposite the surface having the magnetic layer 3b thereon. The back coat layer has a thickness in the range of 0.3 to 1.0 μm, and known suitable materials can be used for the back coat layer 4.

Before the magnetic coating composition is applied directly onto the nonmagnetic support, an undercoat layer, such as an adhesive layer, may be applied to the nonmagnetic support or the nonmagnetic support may be subjected to a pretreatment, such as a corona discharge treatment or an electron beam radiation treatment.

Examples of methods of applying coating compositions to the nonmagnetic support include air doctor coating, blade coating, rod coating, extrusion coating, air knife coating, squeeze coating, impregnation coating, reverse roll coating, gravure coating, transfer roll coating, and cast coating. Other methods can also be used. Furthermore, simultaneous multilayer coating by extrusion coating may be employed.

If necessary, in order to increase the adhesion strength and the like, a layer (undercoat layer) containing the above-mentioned known binder as a main component may be provided between the nonmagnetic support 2 and the lower nonmagnetic layer 3a.

### EXAMPLES

Specific examples are described below, but the present embodiments are not limited to these examples.

Preparation of Magnetic Layer

Coating compositions used for a magnetic layer and the like were prepared on the basis of the compositions described below.

<Preparation of Coating Composition for Upper Magnetic Layer>

Metal magnetic powder: 100 parts by weight
(Average major axis length: 65 nm, coercive force Hc: 210 kA/m, saturation magnetization σs: 130 Am²/kg,
Co content: 24 atomic percent
Al content: 4.7 weight percent
Y content: 7.9 atomic percent

Vinyl chloride copolymer: 10 parts by weight
(Trade name: MR-10; manufactured by Zeon Corporation)

Polyester polyurethane resin: 8 parts by weight
(Phthalate-based polyester polyurethane, number-average molecular weight: 25,000, polar group; SO₃Na, content of the polar group: 0.2 weight percent)

Abrasive material: 10 parts by weight
(Trade name: HIT-50, manufactured by Sumitomo Chemical Co., Ltd.)

Polyisocyanate: 4 parts by weight
(Trade name: CORONATE L, manufactured by Nippon Polyurethane Industry Co., Ltd., The polyisocyanate was added immediately before coating.)

Myristic acid: 1 part by weight

Butyl stearate: 1 part by weight

Methyl ethyl ketone: 80 parts by weight

Cyclohexanone: 80 parts by weight

Toluene: 80 parts by weight

The vinyl chloride copolymer and the polyurethane resin were added to the magnetic powder, and the mixture was appropriately diluted with a solvent composed of methyl ethyl ketone, cyclohexanone, and toluene in a ratio of 1:1:1. The mixture having a solid content of 60% was kneaded with a three-roll.

Subsequently, the paste-like coating composition was diluted with the remaining mixed solvent containing methyl ethyl ketone, cyclohexanone, and toluene using a disper mixer, and the mixture was dispersed with a sand mill together with other additives to prepare a coating solution. The coating solution was then filtered using a filter having a pore diameter of 1 μm and stirred for two hours.

Immediately before coating, 4 parts by weight of the polyisocyanate and 1 part by weight of myristic acid were added to the coating solution, thus preparing a magnetic coating composition for an upper magnetic layer.

<Preparation of Coating Composition for Lower Nonmagnetic Layer>

α-Fe₂O₃ (hematite): 100 parts by weight
(Average major axis length: 70 nm, specific surface area: 55 m²/g, measured by a BET method)

Vinyl chloride copolymer: 15 parts by weight
(Trade name: MR-110; manufactured by Zeon Corporation)

Polyester polyurethane resin: 8 parts by weight
(Isophthalic acid/terephthalic acid/neopentyl glycol-MDI polyurethane, molecular weight: 25,000, polar group: SO₃Na, content of the polar group: 0.2 weight percent)

Abrasive material: 10 parts by weight
(Trade name: HIT-50, manufactured by Sumitomo Chemical Co., Ltd.)

Carbon black: 20 parts by weight
(Trade Name: Bp-L, Manufactured by Cabot Japan K.K.)

Polyisocyanate: 4 parts by weight
(Trade name: CORONATE L, manufactured by Nippon Polyurethane Industry Co., Ltd., The polyisocyanate was added immediately before coating.)

Myristic acid: 2 parts by weight

Butyl stearate: 2 parts by weight

Methyl ethyl ketone: 120 parts by weight

Cyclohexanone: 120 parts by weight

The nonmagnetic powder and a silane coupling agent were mixed with a planetary mixer, and the vinyl chloride copolymer and the polyurethane resin were then added thereto. The mixture was kneaded with a twin-screw extruder.

Subsequently, the paste-like coating composition was diluted with a mixed solvent containing methyl ethyl ketone, cyclohexanone, and toluene using a disper mixer, and the mixture was dispersed with a sand mill together with other additives to prepare a coating solution. The coating solution was then filtered using a filter having a pore diameter of 1 μm and stirred for two hours.

Immediately before coating, 4 parts by weight of the polyisocyanate and 1 part by weight of myristic acid were added to the coating solution, thus preparing a nonmagnetic coating composition for a lower nonmagnetic layer.

<Preparation of nonmagnetic coating composition for back coat>

Carbon Black: 90 Parts by Weight
(Average particle diameter: 20 nm)

Carbon black: 10 parts by weight
(Average particle diameter: 70 nm n)

Polyurethane resin: 25 parts by weight
(MDI polyester polyurethane, molecular weight: 25,000, tertiary amine content: 0.2 weight percent)

Nitrocellulose: 25 parts by weight
(Trade name: NC-1/2H, manufactured by Asahi Kasei Corporation)

Polyisocyanate: 20 parts by weight
(Trade name: CORONATE L, manufactured by Nippon Polyurethane Industry Co., Ltd., The polyisocyanate was added immediately before coating.)

Methyl ethyl ketone: 180 parts by weight

Cyclohexanone: 180 parts by weight

Toluene: 180 parts by weight

The above coating composition for a back coat was kneaded with a three-roll. The mixture was then dispersed with a sand mill. Subsequently, 20 parts by weight of the polyisocyanate was added thereto. The resulting coating solution was then filtered using a filter having an average pore diameter of 1 μm, thus preparing a nonmagnetic coating composition for a back coat.

The prepared coating compositions were applied on each of the films shown in Table 1 by die coating in a wet-on-wet manner to a magnetic layer thickness of 0.13 μm and a lower nonmagnetic layer thickness shown in Table 1. Furthermore, the coating composition for a back coat was applied on each of the films to a thickness of 0.5 μm, and the films were then dried. Each of the original films having a large width was subjected to a seven-stage calendering process at 110° C. and 350 kg/N to form a mirror-like surface. Each of the resulting magnetic films having a large width was cured at 60° C. for 10 hours and then cut so as to have a width of ½ an inch. LTO3 servo signals were then recorded, and each of the films was set in an LTO3 data cartridge to prepare a sample.

TABLE 1

| | | | | | | Media sample | | | | |
|---|---|---|---|---|---|---|---|---|---|---|
| | | | | | | Upper | Lower | Back | | |
| | Nonmagnetic support | | | | | layer | layer | coat | Total | Support |
| | | Tg | Thickness | MD | TD | thickness | thickness | thickness | thickness | thickness/Total |
| | Type | ° C. | μm | N/mm² | N/mm² | μm | μm | μm | μm | thickness |
| Comparative Example 1 | PEN | 155.7 | 6.2 | 7,840 | 6,170 | 0.22 | 1.9 | 0.50 | 8.82 | 0.70 |
| Comparative Example 2 | PEN | 154.6 | 6.2 | 7,630 | 6,360 | 0.13 | 1.4 | 0.50 | 8.23 | 0.75 |
| Comparative Example 3 | PEN | 154.6 | 6.2 | 7,630 | 6,360 | 0.13 | 0.8 | 0.50 | 7.63 | 0.81 |
| Comparative Example 4 | PET | 119.2 | 6.2 | 6,880 | 4,400 | 0.13 | 2.1 | 0.55 | 8.98 | 0.69 |
| Comparative Example 5 | PET | 119.2 | 6.2 | 6,880 | 4,400 | 0.13 | 1.4 | 0.60 | 8.33 | 0.74 |
| Comparative Example 6 | PET | 117.8 | 8.2 | 6,300 | 3,450 | 0.13 | 0.7 | 0.50 | 9.53 | 0.86 |
| Comparative Example 7 | PET | 117.8 | 8.2 | 6,300 | 3,450 | 0.13 | 1.0 | 0.50 | 9.83 | 0.83 |
| Comparative Example 8 | PET | 116.8 | 7.3 | 6,200 | 4,500 | 0.13 | 0.8 | 0.50 | 8.73 | 0.84 |
| Comparative Example 9 | PET | 112.6 | 4.7 | 3,920 | 6,900 | 0.13 | 0.8 | 0.50 | 6.13 | 0.77 |
| Comparative Example 10 | PET | 120.1 | 11.0 | 4,030 | 6,500 | 0.13 | 0.5 | 0.50 | 12.13 | 0.91 |
| Example 1 | PET | 130.1 | 6.7 | 6,800 | 4,800 | 0.22 | 1.6 | 0.55 | 9.07 | 0.74 |
| Example 2 | PET | 130.1 | 6.7 | 6,800 | 4,800 | 0.13 | 0.8 | 0.55 | 8.18 | 0.82 |
| Example 3 | PET | 130.1 | 6.7 | 6,800 | 4,800 | 0.13 | 1.0 | 0.55 | 8.38 | 0.80 |
| Example 4 | PET | 130.1 | 6.7 | 6,800 | 4,800 | 0.13 | 2.2 | 0.55 | 9.58 | 0.70 |
| Comparative Example 11 | PET | 130.1 | 6.7 | 6,800 | 4,800 | 0.13 | 2.2 | 0.70 | 9.73 | 0.69 |
| Example 5 | PET | 128.8 | 6.7 | 6,890 | 4,960 | 0.13 | 0.8 | 0.55 | 8.18 | 0.82 |
| Example 6 | PET | 129.5 | 6.6 | 6,350 | 5,100 | 0.13 | 0.8 | 0.55 | 8.08 | 0.82 |
| Example 7 | PET | 132.5 | 6.7 | 6,180 | 5,000 | 0.13 | 0.8 | 0.55 | 8.18 | 0.82 |
| Example 8 | PET | 125.4 | 6.5 | 6,500 | 5,050 | 0.13 | 0.8 | 0.55 | 7.98 | 0.81 |
| Example 9 | PET | 126.7 | 6.7 | 6,720 | 4,900 | 0.13 | 0.8 | 0.55 | 8.18 | 0.82 |
| Example 10 | PET | 130.5 | 7.0 | 6,770 | 4,990 | 0.13 | 0.8 | 0.55 | 8.48 | 0.83 |
| Example 11 | PET | 130.5 | 7.0 | 6,770 | 4,990 | 0.13 | 0.6 | 0.55 | 8.28 | 0.85 |
| Comparative Example 12 | PET | 130.5 | 6.3 | 6,770 | 4,990 | 0.10 | 0.5 | 0.40 | 7.30 | 0.86 |
| Example 12 | PET | 132.5 | 6.4 | 7,100 | 4,200 | 0.13 | 0.8 | 0.55 | 7.88 | 0.81 |
| Example 13 | PET | 130.2 | 6.0 | 6,350 | 4,000 | 0.13 | 0.8 | 0.55 | 7.48 | 0.80 |
| Example 14 | PET | 131.0 | 5.5 | 6,000 | 5,600 | 0.13 | 0.8 | 0.55 | 6.98 | 0.79 |

| | Electro- | | | | | | | | |
|---|---|---|---|---|---|---|---|---|---|
| | magnetic | | | | | | | | |
| | conversion | | Surface | | | | | | |
| | characteristics | | roughness | Durability | | | | | |
| | Output | C/N | SRa | | ERT after | Storage | TDS | Cut | |
| | dB | dB | nm | Initial ERT × 10⁻⁴ | running × 10⁻⁴ | characteristics | ppm | edge | Blocking |
| Comparative Example 1 | −0.5 | −0.3 | 4.5 | 0.90 | 1.1 | A | 1100 | B | C |
| Comparative Example 2 | 0.0 | 0.0 | 3.4 | 0.30 | 0.52 | A | 1095 | B | C |
| Comparative Example 3 | −0.4 | −0.2 | 3.6 | 0.32 | 0.63 | A | 1095 | B | C |
| Comparative Example 4 | −0.5 | −0.3 | 4.2 | 0.52 | 1.1 | B | 1110 | A | A |
| Comparative Example 5 | −0.2 | −0.1 | 4.1 | 0.21 | 1.2 | B | 1100 | A | A |
| Comparative Example 6 | −1.3 | −0.8 | 4.6 | 5.1 | 5.2 | B | 1350 | A | A |
| Comparative Example 7 | −1.6 | −0.9 | 4.0 | 6.2 | 5.9 | B | 1350 | A | A |
| Comparative Example 8 | −0.6 | −0.4 | 4.6 | 1.2 | 1.4 | B | 1210 | A | A |
| Comparative Example 9 | −1.0 | −1.3 | 3.2 | 25 | * | C | 1010 | B | A |
| Comparative Example 10 | −3.0 | −1.5 | 6.4 | 40 | 15 | A | 1020 | A | A |
| Example 1 | 0.0 | 0.0 | 3.7 | 0.51 | 0.42 | A | 1060 | A | A |
| Example 2 | 0.6 | 0.3 | 3.4 | 0.23 | 0.24 | A | 1060 | A | A |
| Example 3 | 0.4 | 0.2 | 3.6 | 0.13 | 0.16 | A | 1060 | A | A |
| Example 4 | 0.8 | 0.4 | 3.2 | 0.15 | 0.18 | A | 1060 | A | A |
| Comparative Example 11 | 0.7 | 0.3 | 3.3 | 0.18 | 1.02 | A | 1060 | A | A |
| Example 5 | 0.2 | 0.1 | 3.7 | 0.20 | 0.21 | A | 1030 | A | A |
| Example 6 | 1.0 | 0.7 | 3.2 | 0.08 | 0.12 | A | 1010 | A | A |
| Example 7 | 0.4 | 0.2 | 3.5 | 0.19 | 0.18 | A | 1020 | A | A |
| Example 8 | 0.8 | 0.5 | 3.3 | 0.10 | 0.09 | A | 1010 | A | A |
| Example 9 | 0.3 | 0.2 | 3.5 | 0.23 | 0.18 | A | 1050 | A | A |
| Example 10 | 0.6 | 0.3 | 3.4 | 0.20 | 0.17 | A | 1030 | A | A |
| Example 11 | 0.2 | 0.2 | 3.6 | 0.25 | 0.24 | A | 1030 | A | A |
| Comparative Example 12 | −0.1 | −0.1 | 4.3 | 0.80 | 1.32 | A | 1030 | A | A |
| Example 12 | 0.5 | 0.3 | 3.4 | 0.10 | 0.13 | A | 1090 | A | A |
| Example 13 | 0.9 | 0.4 | 3.3 | 0.12 | 0.14 | A | 1150 | A | A |
| Example 14 | 0.9 | 0.4 | 3.3 | 0.15 | 0.93 | A | 950 | A | A |

* could not be measured.

Measurement Methods

(Measurement of Electromagnetic Conversion Characteristics)

The electromagnetic conversion characteristics were measured with a fixed-head electromagnetic conversion characteristic measuring device. This measuring device includes a rotatable drum and a head that is brought into contact with the drum, and a magnetic tape is wound around the drum.

First, square wave signals of 13 MHz were recorded at an optimum recording current of each magnetic tape under the conditions described below. Subsequently, the output level at 13 MHz was detected with a spectrum analyzer, and a carrier value at 0.195 μm was determined as a medium output C.

When square wave signals of 0.195 μm were written, a value calculated by integrating a value determined by subtracting the output and system noise from spectrum components corresponding to a recording wavelength of 0.195 μm or more is defined as a noise value N. The ratio of the medium output C to the noise value N was represented by C/N. Both the medium output C and the ratio C/N in Comparative Example 2 were defined as 0 dB. These values for the other samples were calculated on the basis of the values obtained in Comparative Example 2.

Linear recording density: 260 kfci (λ=0.195 μm)

Minimum recording frequency: 13 MHz

Linear velocity: 100 ips (2.53 m/sec)

(Measurement of Surface Roughness)

Each of the prepared samples having a width of ½ an inch was sampled so as to have dimensions of 5 mm×5 mm. The surface roughness of each sample was measured under the following conditions using an AFM Nanopics 2100 Compact Tabletop Probe Microscope manufactured by SII Nanotechnology Inc. The center line average roughness (SRa) and the 10-point average roughness (SRz) were determined.

Spring constant: 40 N/m

Resonant frequency: 250 to 300 kHz

Cantilever length: 120 μm

Cantilever configuration: single beam

Scanned area: 40 μm×40 μm

Scan line: 256 lines/scan area

Scan speed/scan area: 90 sec

(Measurement of Durability)

An LTO3 cartridge was prepared using each prepared tape. Recording and reproducing were performed using an LTO3 drive (Ultrium 960) manufactured by Hewlett-Packard Development Company, L.P. in a test mode, thus determining an error rate (ERT) before running. Furthermore, all the tracks present in the overall length were run for 600 hours in an environment of 40° C. and 80% RH. Reproducing was then performed and an error rate was determined.

(Measurement of Storage Characteristics)

An LTO3 cartridge was prepared using each prepared tape. Subsequently, 200 GB of data was recorded using an LTO3 drive (Ultrium 960) manufactured by Hewlett-Packard Development Company, L.P. at room temperature in a test mode. The cartridge was then stored in a thermostatic chamber in an environment of 45° C. and 80% RH for one week. (It is believed that storage in this environment for this length of time is equivalent to storage in a normal environment for 30 years.) After the storage, the cartridge was left to stand at room temperature for 24 hours. The data was then reproduced using the LTO3 drive (Ultrium 960) manufactured by Hewlett-Packard Development Company, L.P. to confirm the reproducibility of the data. The storage characteristics were evaluated on the basis of the following criteria.
A: The backup data could be reproduced without any hard errors.
B: Off-track due to deformation of the tape occurred in some of the tracks, thereby increasing the error rate.
C: All of the data could not be reproduced because of the generation of hard errors.

(Measurement of Transverse Dimensional Stability (TDS))

The LTO3 drive was placed in a thermostatic chamber and the transverse dimensional stability (TDS) was then measured in accordance with an LTO standard described in Ultrium Generation 3 16-Channel Format Specification Document U-316, Section 9.17.

According to the standard of Ultrium Generation 3, the TDS is 0.12% (1,200 ppm) or less.

(Confirmation of Productivity and Cut Edge)

The cut edge cross section of each tape after cutting was observed with an optical microscope at a magnification ratio of 200 and evaluated on the basis of the following criteria.
A: No cracks were observed on the cut edge, which was satisfactory.
B: Some cracks were observed but a high-edge phenomenon did not occur.
C: A high-edge phenomenon occurred, and the tape could not be used as a medium.

(Blocking Characteristic)

Each of original film rolls after coating (about 1,000 m) was stored at 5° C. for 24 hours. Condensation was then allowed to form on the film in an environment of 40° C. and 80% RH.

Subsequently, each of the film rolls was left to stand in a room temperature environment (23° C., 50% RH) for 24 hours. Whether blocking occurred or not was then confirmed using a cutting machine set to cut ½-inch-width films. The blocking characteristic was evaluated as follows. The blocking characteristic was evaluated on the basis of the following criteria.
A: Blocking did not occur.
C: The film became split in the course of cutting because of the occurrence of blocking.

(Measurement of Glass Transition Temperature (Tg))

Each of the nonmagnetic support films was cut so as to have dimensions of 5 mm×40 mm. The glass transition temperature (Tg) was measured with a RHEOVIBRON MODEL RHEO-2000 dynamic viscoelastometer manufactured by Orientec Co., Ltd. at a measurement frequency of 3.5 Hz, and at a temperature-increasing rate of 2.0° C./min.

(Measurement of Young's Modulus)

The Young's modulus was measured in accordance with JIS-K7133 and ASTM D882 using a sample having a width of 6.25 mm and an effective length of 100 mm at a tensile speed of 200 mm/min. A value calculated by dividing the tensile strength that provides 1% elongation by the cross sectional area of the initial film is defined as E (Young's modulus).

Referring to Table 1, in Comparative Examples 1 to 3, a nonmagnetic support made of polyethylene-2,6-naphthalate (PEN) was used. In Comparative Example 1, coating was performed so that the formed magnetic layer had a thickness of 0.22 μm and the recording medium sample had a total thickness of 8.82 μm. When the results of Comparative Example 1 were compared with the results of Example 1 of the present invention, which had substantially the same thickness ratio as Comparative Example 1, the electromagnetic conversion characteristics in Comparative Example 1 were seen to be somewhat inferior to those in Example 1 and the error rate in Comparative Example 1 also tended to be increased. In particular, blocking occurred in Comparative Examples 1 to 3 in which the PEN film was used. These results were inferior to those obtained in the cases of a PET film.

In Comparative Examples 4 and 5, a PET film having a Tg of about 120° C. was used. After the samples of Comparative Examples 4 and 5 were stored in a high-temperature and high-humidity environment, deformation was observed at an edge of the samples. Consequently, the error rate was locally increased in recording tracks disposed near the edge.

In Comparative Examples 6, 7, and 8, a PET film having a low Tg was used as in Comparative Example 4. In all these comparative examples, the results showed that the error rate after the storage was increased.

In Comparative Example 9, a PET film having a small thickness of 4.7 μm was used. This base film had an inversed strength ratio (MD-TD ratio) compared with films of most of the other examples. Since the base film had a low strength in the longitudinal (MD) direction, elongation easily occurred during the running in the drive. Consequently, the error rate was increased during the running in the durability test, and running could not be continued for 100 hours.

In Comparative Example 10, the base film also had a low strength in the longitudinal direction. This sample of Comparative Example 10 was prepared in order to examine whether or not the results could be improved by increasing the thickness of the base film having a low strength in the longitudinal direction. According to the results, the deformation of the base film during the running could be decreased. However, since this sample had a large total thickness, the recording capacity per unit volume was decreased by 30% or more compared with the sample in Example 2 and the like. Accordingly, this structure could not be used as a practical solution.

In contrast, in the present Examples 1 to 13, satisfactory results were obtained in all the samples. More specifically, in Examples 1 and 2, in which a PET film having a Tg of 130° C. was used, blocking that was observed in Comparative Examples 1 and 2 did not occur. Furthermore, satisfactory results were obtained in practical characteristics such as the electromagnetic conversion characteristics and durability, compared with those in Comparative Examples 1 and 2.

In Example 4 and Comparative Example 11, the ratio of the thickness of the base film (i.e., nonmagnetic support) to the total thickness was small. In particular, in Comparative Example 11 in which the above ratio was lower than 0.7, since the rigidity of the entire tape including the coating films was excessively high, the force of the contact (contact property) on the head became strong. Consequently, the error rate was increased after running was performed many times.

In Example 11 and Comparative Example 12, the ratio of the thickness of all the coating films to the total thickness was small. When the thickness of the coating films including the lower layer serving as a supply source of a lubricant was decreased, as the friction increased during repeated running, the error rate was increased and the C/N was also degraded because the magnetic recording medium directly received the effect of irregularities on the surface of the base film. Accordingly, a ratio of the thickness of the nonmagnetic support to the total thickness in the range of 70% to 85%, which is within the range of the thickness ratio specified in the present embodiments, is more effective.

In Examples 4 to 10, a PET film having a Tg of 125° C. or higher, which is within the range of the present invention, was used. These samples satisfied all the characteristics. For example, in Examples 5 to 7, the ratio of the strength in the TD direction of the base film to the strength in the MD direction was increased. The values of TDS in Examples 5 to 7 were improved by 10 to 20 ppm compared with the TDS in Example 4.

In Examples 12 and 13, the strength in the TD direction of the PET film was decreased. The value of TDS in Example 13 was degraded by about 100 ppm compared with that in Example 4. Accordingly, in order to satisfy the standard of LTO3, it is necessary to control the Young's modulus in the TD direction to 4,000 N/mm² or more. In Example 14, the strength in the MD direction and the strength in the TD direction of the PET film were substantially the same. In Example 14, since the strength in the MD (longitudinal) direction was low, the error rate after repeated running tended to be increased because of the same reason as in Comparative Examples 9 and 10, as described above.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A magnetic recording medium comprising:
a nonmagnetic support;
a lower nonmagnetic layer in which a nonmagnetic powder is dispersed in a binder and which is provided on the nonmagnetic support; and
a magnetic layer in which a magnetic powder is dispersed in a binder and which is provided on the lower nonmagnetic layer,
wherein the nonmagnetic support is made of a polyethylene terephthalate having a glass transition temperature of 125° C. or higher, and
the ratio of the thickness of the nonmagnetic support to the total thickness of the magnetic recording medium is in the range of 70% to 85%.

2. The magnetic recording medium according to claim 1, wherein the nonmagnetic support is made of a polyethylene terephthalate having a Young's modulus in the longitudinal direction of 6,000 N/mm² or more and a Young's modulus in the width direction of 4,000 N/mm² or more.

3. The magnetic recording medium according to claim 1, wherein the nonmagnetic support has a thickness of 7 μm or less.

4. The magnetic recording medium according to claim 2, wherein the nonmagnetic support has a thickness of 7 μm or less.
